(19) United States
(12) Patent Application Publication
(10) Pub. No.: US 2020/0125709 A1
(43) Pub. Date: Apr. 23, 2020

(54) TAGGING SYSTEM FOR SIMILARITY-BASED RETRIEBAL

(71) Applicant: Zenus, Inc., Houston, TX (US)

(72) Inventors: Ricky Gentry, Houston, TX (US); Panagiotis Moutafis, Houston, TX (US); Rakshak Talwar, Houston, TX (US)

(21) Appl. No.: 16/593,663

(22) Filed: Oct. 4, 2019

Related U.S. Application Data
(60) Provisional application No. 62/742,169, filed on Oct. 5, 2018.

(51) Int. Cl. G06F 21/32; G06F 21/64; G06F 16/435; G06F 16/58; G06F 11/30

(52) U.S. Cl. CPC G06F 21/32; G06F 21/64; G06F 11/3089; G06F 16/5866; G06F 16/436

(57) ABSTRACT

A tagging system for similarity-based retrieval operations is disclosed. A biometric system configured with the tagging system according to the aspects of the present disclosure receives biometric signatures into a gallery for enrollment in system. One or more logical tags are then associated to each known biometric signature within the gallery. When a desired functionality for the biometric system is determined, a combination of logical tags that define the desired functionality are used to generate a search space. The search space includes a subset of all biometric signatures of the gallery having the corresponding combination of logical tags. The biometric system may then compare a test image probe against each of the biometric signatures of the search space.

### CROSS-REFERENCE TO RELATED APPLICATIONS

This application claims the benefit of U.S. Provisional Patent Application No. 62/742,169, entitled, “TAGGING SYSTEM FOR SIMILARITY-BASED RETRIEVAL,” filed on Oct. 5, 2018, which is expressly incorporated by reference herein in its entirety.

### BACKGROUND

### Field

Aspects of the present disclosure relate generally to data retrieval systems, and more particularly, to a tagging system for similarity-based retrieval operations.

### Background

The practice of restricting or monitoring access to any system or area may beneficially involve reliable identification techniques. The earliest techniques may have involved simply an individual that personally knew and recognized each other individual attempting access to the system or area. As the population of participants grow beyond one person's ability to recognize and know each participant, and the systems or areas include Internet-based systems, identification techniques moved to knowledge, token, or key-based techniques, such as passwords, keycards, passcodes, token generators, two-factor identifications, and the like. However, knowledge, token, or key-based identification and authentication techniques are inherently vulnerable to failure. User's forget passwords, or worse, use simple-to-break passwords, or leave passwords exposed to unauthorized viewing. Keycards or token generators are lost or stolen. Such vulnerabilities necessarily leave the restricted systems or areas vulnerable to unauthorized access.

As computer processing power has steadily increased along with advancements in biometric recognition algorithms, use of biometrics in identification and authentication has become a viable means for controlling access or use to such restricted systems or areas. Biometrics generally refers to the science of establishing an individuals' identity based on known physical and behavioral traits, such as fingerprints, facial imaging, iris or retinal configuration, voice pattern, and gait. Compared to traditional authentication schemes that are knowledge-based, token-based, or key-based, biometric-based systems can be considered more convenient and secure. Users no longer have to memorize passwords, carry keycards, token generators, or possess proof of identity, such as ID cards, while impostors can be deterred or detected with increased accuracy. Hence, biometric systems have been deployed in numerous commercial, civilian, and forensic applications to establish identity and authentication.

Biometric systems that compare a detected biometric datum (e.g., a fingerprint, a facial image, eye or retinal scan, voice sample, gait recording, etc.), referred to as a probe, against a database of known biometric data, in which the known biometric data may be referred to as biometric signatures and the database may be referred to as a gallery, are implementations of similarity-based retrieval systems, as the probe is compared against entries in the gallery to detect the level of similarity.

Other implementations of similarity-based retrieval systems provide galleries of data signatures (e.g., images, audio, video, etc.) that may not be precisely distinguishable without similarity-based comparisons and probabilistic determination. Such systems may be used automated medical diagnosis, geographic information science data analysis, music search applications, and the like. An analyzed similarity between the probe and data signatures within the gallery that exceeds a predetermined threshold confidence level may be returned as a positive identification or authentication. As the number of entries in the gallery increases, there has been shown to be an inverse proportionality of the accuracy of the data retrieval. Additionally, as the number of data signatures in the gallery increases, and, perhaps, the granularity of the recognition points within each data signature increases with an increased resolution of probe and signature, the processing complexity and time required to authenticate the probe increases. In some applications, the time may increase beyond a point where it makes sense to use such similarity-based retrieval system for its intended purpose. For example, if used in a biometric system to authenticate passengers boarding a bus or train or plane, the increased time may unnecessarily increase the turnaround time of each vehicle, thus, costing the vehicle operator more money caused by either vehicle downtime waiting for all passengers to pass through authentication or operating more empty trips as all passengers were not able to finish authentication prior to scheduled departure time.

Similarity-based retrieval systems may generally either use a naïve search algorithm or a clustering search algorithm to search the gallery for identification. In a naïve search system, the biometric system compares the probe against each data signature in the gallery. No search optimization is applied for reducing the number of comparisons that are performed to authenticate the probe. Such a data retrieval system will search the probe against all data signatures.

A clustering-based search system prepares the gallery as an optimized searchable structure. That is, similar data signatures are grouped together in clusters. Such a cluster may represent multiple signature types from the same person or item or a collection of signature types from multiple people or items that are similar according to the data signature. This gallery preparation time is not trivial and adds to the total time used for clustering-based searches. Moreover, a clustering-based approach may introduce inaccuracy into the search process. During the testing, the system computes pairwise similarity measures between the probe and each cluster. The probe is then compared with the data signatures within each cluster for which the similarity rises to a threshold level. While this reduces the computational time for the comparison, as it reduces the number of comparisons performed, the probe is not compared against all data signatures in the gallery, which could end up returning either false positive or negative matches.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a legacy biometric system.

FIG. 2 is a block diagram illustrating example blocks executed to implement one embodiment of the present disclosure.

FIG. 3 is a block diagram illustrating a biometric system configured according to one embodiment of the present disclosure.

FIG. 4 is a block diagram illustrating additional aspects of the biometric system configured according to one embodiment of the present disclosure.

FIG. 5 is a block diagram illustrating a biometric system configured according to one aspect of the present disclosure.

FIG. 6 is a block diagram illustrating a data retrieval system configured according to one aspect of the present disclosure.

### DETAILED DESCRIPTION

Certain terms are used throughout the following description and claims to refer to particular system components. As one skilled in the art will appreciate that different individuals or companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be based on Y and any number of other factors.

In the drawings and description that follow, certain features of the invention may be shown exaggerated in scale or in somewhat schematic form, and some details of conventional elements may not be shown in the interest of clarity and conciseness. The present disclosure is susceptible to embodiments, implementations, and aspects of different forms. Specific embodiments are described in detail and are shown in the drawings, with the understanding that the present disclosure is to be considered an exemplification of the principles of the disclosure and is not intended to limit the scope of the disclosure to that illustrated and described herein. It will be apparent to those skilled in the art that these specific details are not required in every case and that, in some instances, well-known structures and components are shown in block diagram form for clarity of presentation. It is to be fully recognized that the different teachings and components of the embodiments and aspects discussed below may be employed separately or in any suitable combination to produce desired results.

Data retrieval systems that use a similarity-based retrieval operation intend to take a given unidentified object, search a database of known objects, and determine whether there is a match based on the similarity of the unidentified object to any of the known objects. However, the processing functionality of current data retrieval systems experience inefficiency and potential inaccuracy errors due to deficient structure and strategies for identification or authentication of the unidentified object. In order to increase the use of data retrieval systems to a greater number of diverse applications, there would be a benefit in the art to improve the structure and operations of the similarity-based retrieval operations.

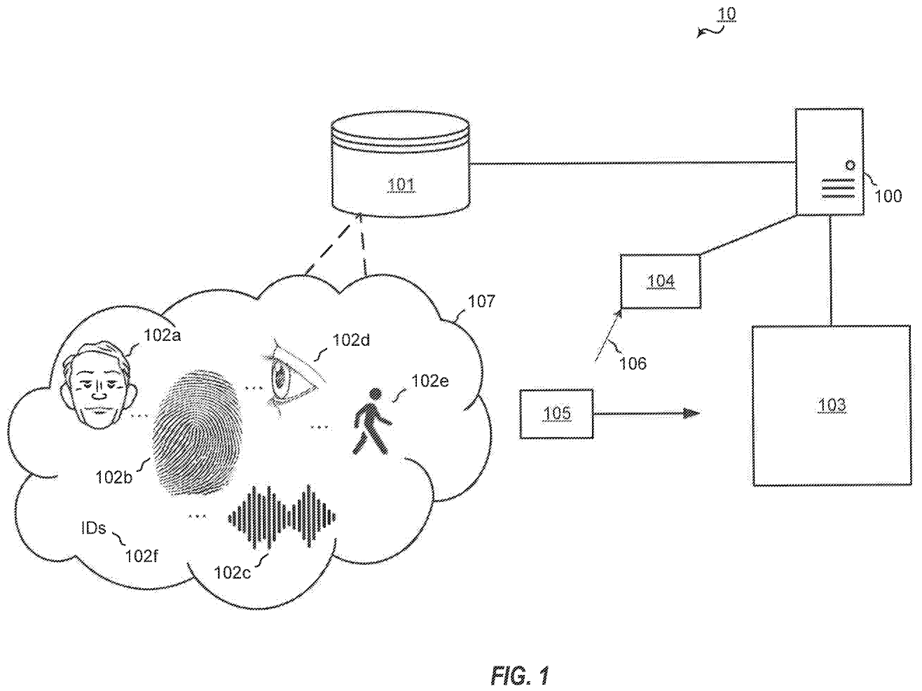

FIG. 1 is a block diagram illustrating a legacy biometric system 10. Legacy biometric system 10 operates an existing similarity-based retrieval system that includes, generally, a computational system, such as computer 100, coupled to memory structure or facilities, such as database 101. Computer 100 and database 101 may be separately coupled, as illustrated, may be both parts of a single system unit, or some combination of combined and distributed components, including both distributed memory and computing components that share communications and instructions via physical and/or wireless couplings. Database 101 stores the gallery of biometric signatures known to legacy biometric system 10. For example, biometric signatures may include facial images 102a, fingerprints 102b, voice samples 102c, iris or retinal images 102d, and gait samples 102e. Depending on the application of legacy biometric system 10, any one or combination of such types of biometric signatures may be stored at database 101 for use in similarity-based identification or authentication.

To illustrate the limitations of existing biometric systems, the functionality of legacy biometric system 10 will be described as a facial recognition embodiment of a similarity-based retrieval system. It should be noted that the limitations and deficiencies of such existing biometric systems are not limited only to facial recognition operations.

For the example illustrated in FIG. 1, legacy biometric system 10 is used to implement functionality 103. Functionality 103 may comprise various different functionalities, such as entry to a restricted-access area, identification of an individual arriving at an airport, authentication of a customer at a bank, identification and authentication of a user to operate a mobile device, or the like. To establish legacy biometric system 10, users enroll in the system by submitting images of themselves to a face recognition service (mobile device, photo kiosk, registration location, etc.). For each such user, a corresponding entry of facial images 102a is made into database 101 that includes a unique identifier (ID) and the corresponding biometric signature (facial images 102a) extracted for that user. The set of unique IDs and the extracted biometric signatures (facial images 102a) constitute the gallery 107. Once the enrollment process has been completed, test images may be submitted as recognition queries.

In operation, user 105, who is enrolled in legacy biometric system 10, intends to access functionality 103. A biometric scanner 104 captures a test image 106 as user 105 attempts to access functionality 103. Biometric scanner 104, which for a facial recognition system as in the currently described example by comprise a camera, is coupled to legacy biometric system 10, perhaps via computer 100. For each such test image 106 captured by biometric scanner 104, computer 100 extracts a biometric signature and compares it against the stored biometric signatures (facial images 102a) in database 101. This may occur either (i) naively across all of the entries of database 101 or (ii) through a pre-constructed search structure, depending on how legacy biometric system 10 is configured for operation. Based on these comparisons, legacy biometric system 10 returns a list of potential matches and determines whether user 105 is able to access functionality 103.

As described below, the time complexity of existing naïve and clustering similarity search methods is provided using big-O notation along with a brief description of how methods within each of the two categories work. Big-O notation is a standard mathematical notation used to classify or rate algorithms according to the runtime or space used associated with a growing number of inputs. Each search method may be analyzed for computation of the search structure, updating the search structure, and performing an active query. The time and complexity of these three tasks in combination may provide a determination of the efficiency of the search method.

When configured for naïve searching, legacy biometric system 10 would not need to compute a search structure. Instead, legacy biometric system 10 measures the similarity between the probe (test image 106) and each of the stored signatures (facial images 102a). Computer 100 may then sort the computed measures by value and compare against a threshold similarity. Because naïve search systems do not compute a search structure, no processing time is expended either to compute or update the search structure. However, the query process results in an efficiency classification of O(n*log(n)), where n is the number of signatures in gallery 107.

When configured with a clustering-based search methodology, legacy biometric system 10 stores the biometrics signatures (facial images 102a) in an optimized searchable structure within database 101. In forming this optimized searchable structure, each instance of facial images 102a is grouped into clusters of similar images. For example, a cluster may represent multiple images from a single person or a collection of images of multiple people who have similar appearances according to the facial recognition algorithm being used. The time complexity for computing and populating the clusters may further depend on the clustering algorithm selected (e.g., k-means, spectral, rank-order, etc.). However, this step of computing and populating the clusters for the optimized searchable structure is computationally expensive because it requires at least a partial construction of a similarity matrix between all of the gallery samples in addition to an iterative refinement of clusters. These computations may often have polynomial time complexity. Moreover, as gallery 107 changes, the clusters may need to be recomputed, thus, adding more time to the initial processes of establishing legacy biometric system 10.

In operation of legacy biometric system 10 configured with clustering search capabilities, legacy biometric system 10, via computer 100, computes pairwise similarity measurements between the probe (test image 106) and each cluster within gallery 107. For each cluster that are determined based on some threshold “similarity” or “closeness” criteria to the probe, legacy biometric system 10 will compare each member of the identified cluster to the probe. Legacy biometric system 10 then sorts the computed measures by value and further compares those measures against a threshold similarity to return a list of potential matches. Computation of the search structure in such clustering-based systems results in an efficiency classification of: O(n\hat{ }t), where n is the number of signatures in gallery 107 and 1<t≤2, where t depends on the clustering algorithm and other tuning parameters. Updating the search structure (clusters) in clustering-based systems will typically result in the same efficiency classification as computing the structure O(n\hat{ }t). The query process for clustering-based systems results in an efficiency classification of O(k*m), where k is the number of target clusters and m is the number of signatures assigned to each cluster (assuming all clusters have roughly the same number of signatures). A target cluster is a cluster that is deemed likely to contain a matching signature. For instance, assuming 10 clusters, for a given probe, a clustering search algorithm computes a distance with each cluster and may be confident that three of them may contain the matching signature. Thus, the number of target clusters in this example would be, k=3.

In examination of such clustering-based search mechanisms, even though such methods manage to reduce the query time by reducing the search space, the probe is not compared with all the samples in gallery 107. Hence, when legacy biometric system 10 is configured to use a clustering-based operation additional errors may be introduced. Moreover, despite a reduction in query timing over naïve search systems, configuring the parameters of the clustering algorithms is not trivial. Therefore, the system must calculate the structure multiple times for it to work as expected in addition to the time that may be expended to update the search structure as subjects or signatures are newly enrolled or un-enrolled from the system.

In order to address the problems and processor inefficiencies of current similarity-based data retrieval systems, various aspects and embodiments of the present disclosure are directed to associating logical tags to the store of known data signatures. Similarity searches of a gallery of signatures tagged in such a manner may be performed on logically reduced search spaces, in which the probe is compared against all signatures of the logically reduced search space. Compared with a naïve search process, the advantages of the proposed improved process are evident in the reduction of the search space complexity from O(n) to O(f), where f≤n. Considering the additional procedure to sort results, the complexity of the proposed improved process is reduced from O(n*log(n)) to O(f*log(f)). In most similarity-based data retrieval systems, accuracy and speed improvements are both proportional to a decrease in size of the targeted search space. Using the logical tags to efficiently subdivide the gallery, the desired results can be obtained with less hardware investment while maintaining search efficiency and accuracy.

Compared with clustering-based approaches, the advantages of the proposed improved process lie in its flexibility. Computation of a legacy cluster search structure can take hours or days depending upon the size of the enrollment set. The proposed logical tagging system for similarity-based data retrieval systems can efficiently compute and maintain the search structure in a one-to-one process regardless of the number or frequency of updates to the enrollment set. In addition, existing clustering-based approaches often require fine tuning of the cluster search structure which make them cumbersome for real-world deployments. In contrast, the proposed improved system is intuitive and easy to use. In fact, data retrieval systems that use a logical tagging system for similarity-based identification result in higher scalability and efficiency in terms of the computations required.

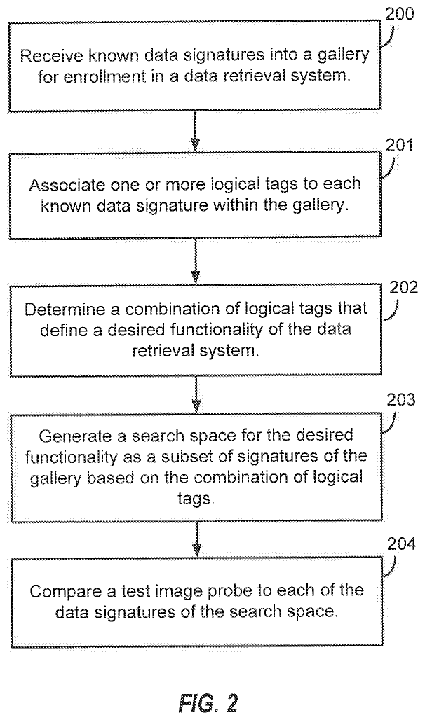

FIG. 2 is a block diagram illustrating example blocks executed to implement one embodiment of the present disclosure. At block 200, a data retrieval system receives known data signatures into a gallery for enrollment in the data retrieval system. The logical tagging system of the present disclosure operates in known-information data retrieval systems where known data signatures are received and added to a gallery in advance for the user to enroll in participation with the system functionality. Such data retrieval systems may be implemented as biometric authentication/identification systems, predictive medical diagnosis systems, music, and image search applications, and the like.

At block 201, the data retrieval system associates one or more logical tags to each known data signature within the gallery. For each data signature received into the gallery, one or more logical tags are associated with the signature. The logical tags provide additional privileged information that may describe a characteristic or trait of the signature or the user or both. For example, in an employment context, logical tags may include work title, work location, work team, and the like. In a general identification context, logical tags may include home address, membership information, a location-based tag, such as global positioning system (GPS) coordinates, and the like. The generation of the logic tags may be manual, by users or personnel of the system operator, or may be automatic, such as through automated observation or based on artificial intelligence or rule-based functionality monitoring the system and activities surrounding the system. A data retrieval system with a logical tagging capability to similarity-based operations may also provide dynamic functioning, such that the functionality to be controlled by the data retrieval system is not a permanent functionality. For example, a seminar company using a biometric system configured according to an embodiment of the present disclosure may enroll registrants for attendance at a particular seminar on a particular date or set of dates. In such an example operation, the logical tags may identify a registrant, a speaker, a very important person (VIP) attendee, seminar location, individual sessions registered for, and the like. Such tags may only be effective or useful during the time period and location of the given seminar.

At block 202, the data retrieval system may then determine a combination of logical tags that define a desired functionality of the data retrieval system. When defining the functionality or functionalities to be controlled by the data retrieval system, a combination of logical tags may be used to define the operation of the functionality. For example, with reference to the seminar example discussed above, one functionality may be access to a back stage area for speakers. If such access were controlled via facial recognition and cameras installed near the backstage door, a combination of tags may include only the speaker tag. Another separate functionality may be access to course material, in such functionality, the combination of tags may be registrant and seminar location. In an employment context example, access to a particular workroom may be controlled by a combination of tags such as work title and work location. Operators of the data retrieval system may define a particular functionality using such combinations of logical tags out of the collection of all logical tags defined in the data retrieval system.

At block 203, the data retrieval system generates a search space for the desired functionality as a subset of signatures of the gallery based on the combination of logic tags. After determining the combination of logical tags to define the functionality for control, the data retrieval system will generate a specific search space for that functionality. Generating of the search space is also referred to as structure computation. The specific search space or structure will be a subset of the entire gallery of data signatures corresponding to the data signatures that share the combination of logical tags. In some example applications, the specific search space will only include data signatures that include the exact combination of tags, while other applications may include data signatures that include any one or more of the determined combination of tags. Moreover, depending on the application, common combinations of tags that serve a common functionality may be generated in advance and saved in order to increase the efficiency of the identification and authentication process. Other applications may dynamically generate the search space as the combination of logical tags is determined for a particular functionality.

At block 204, the data retrieval system compares a test image probe to each of the data signatures of the search space. After the specific search space is generated for the particular functionality, a test image probe captured by a sensor may be compared to each of the data signatures in the specific search space. Using the logical tagging system, the data retrieval system is capable of generating a search space that is smaller than the entire gallery using privileged information that creates a more logical set of target signatures to search from. This process not only reduces query time by generating the smallest logical search space, computation and updating of the search structure may occur linearly. In big-O notation terms, the efficiency classification of structure computation results in O(n), where n is the number of signatures in the gallery, structure updates result in an efficiency classification of O(1), which translates into a one-to-one process where updates are equivalent only to the number of signatures being updated, and the query time results in an efficiency classification of O(f*log(f)), where f is the number of signatures in the specific search space after applying the logical tag combination filter, and n is the number of signatures in gallery, where f≤n.

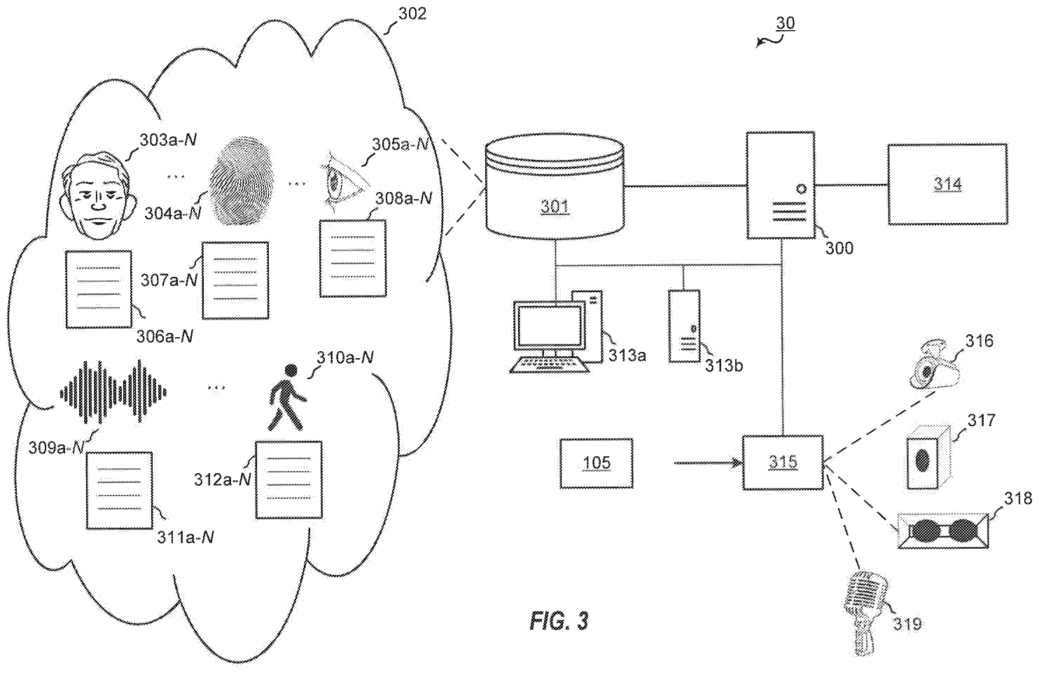

FIG. 3 is a block diagram illustrating a biometric system 30 configured according to one embodiment of the present disclosure. Biometric system 30 includes computer system 300 coupled in some fashion to database 301. Database 301 is used to store gallery 302 of biometric signatures, such as facial images 303a-N, fingerprints 304a-N, iris or retinal images 305a-N, voice samples 309a-N, and gait samples 310a-N, wherein N represents an unfixed number according to the total number of biometric signatures of each type stored. Users, such as user 105, who subscribe or enroll with biometric system 30 to, for example, participate in functionality 314, may submit such known biometric signatures via sensor 315. Depending on the operations and capabilities of biometric system 30, sensor 315 may include any number of different types of biometric sensors, such as camera 316, fingerprint reader 317, iris or retinal scanner 318, or audio recorder 319. User 105 uses sensor 315 to capture a biometric signature and submits the signature for enrollment with biometric system 30. Pre-existing biometric signatures already in possession of the system operator may also be added via computer 313a. The signatures are stored within gallery 302 of database 301.

As a part of enrollment with biometric system 30, one or more logical tags may be entered into gallery 302 associated with a particular biometric signature. Such logical tags may be entered via computer 313a. While illustrated as a desktop computer system, computer 313a may, in fact, comprise any number of different computing-capable devices, including mobile devices, kiosks, interactive voice response units, and the like. The logical tags may be entered by user 105, by an operator associated with biometric system 30 or with functionality 314, or automatically, by drawing from known associated information (e.g., mobile phone number via a mobile device, mobile equipment identifier (MEID) from the mobile device, internet protocol (IP) address from a connected computer, etc.). Automatic generation of logical tags may further be implemented using artificial intelligence-based or rules-based tag generation. For example, machine learning functionality operating on server 313b monitors operations of biometric system 30 and functionality 314 to enter, update, or refine the logical tags into gallery 302 of database 301. In one example implementation, machine learning functionality on server 313b observes an employee entering a restricted building at the same time each day. The machine learning functionality automatically adds a logic tag, such as logical tags 306a-N to gallery 302 in database 301 associated with the employee that identifies arrival time at the building. As illustrated, logical tags 306a-N are associated with facial images 303a-N, logical tags 307a-N are associated with fingerprints 304a-N, logical tags 308a-N are associated with iris or retinal images 305a-N, logical tags 311a-N are associated with voice samples 309a-N, and logical tags 312a-N are associated with gait samples 310a-N.

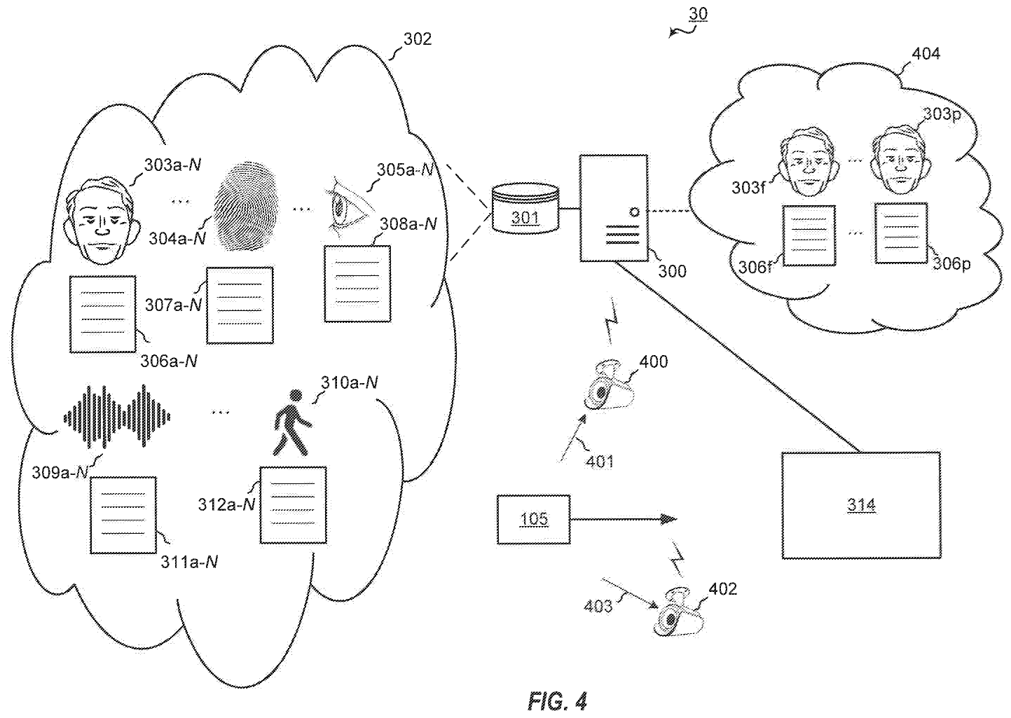

FIG. 4 is a block diagram illustrating additional aspects of biometric system 30 configured according to one embodiment of the present disclosure. The various aspects of the present disclosure relate generally to a data retrieval system, such as biometric system 30, performing a type of clustering using privileged information (e.g., logical tags) gallery 302. Search space 404 used to perform functionality 314 may be restricted by selecting the subset biometric signatures of gallery 302 of all enrolled users that satisfy the determined logical tag combination. For example, returning to the facial recognition example for a seminar, considering access to a special refreshments room for speakers and VIPs, a combination of logical tags identifying “speaker” and “VIP” is generated. Functionality 314 includes restricted access to a locked refreshments room monitored by cameras 400 and 402. Because this special refreshments room is planned in advance, the special search space may be generated in advance and stored specifically to control functionality 314 (access to the locked room). Applying the speaker/VIP filter for facial recognition functionality to gallery 302, computer 300 generates search space 404, which results in facial images 303f-p having logical tags 306f-p corresponding to either “speaker” or “VIP.” This type of computation is linear in time complexity. It can be generated in advance and stored in memory, as illustrated in FIG. 4, or performed for each query dynamically. The update operation is also constant in time complexity for all updates to the enrollment set. Unlike existing clustering-based approaches, there is no reduction in accuracy. The probe would be compared against each biometric signature that shared the logical tags identified for generation of search space 404. Accordingly, biometric systems that use a logical tagging operation according to the various aspects of the present disclosure improve the similarity-based processing and reduce the computational complexity while doing so in a system with a better overall efficiency classification.

In operation, user 105, is a speaker at the seminar. User 105 approaches the special refreshments room (functionality 314) passing cameras 400 and 402 which capture test images 401 and 403. Biometric system 10 uses test images 401 and 403 as probes to compare against each biometric signature within search space 404. In order to define the proposed features of the present disclosure in further detail, additional notation may be provided. Let P be the set of all enrolled persons. S_p represents the set of signatures for a person p, where p∈P. T represents the set of all logical tags that are being used, where T_p represents the exact combination or subset of logical tags associated to a person p, where T_p ⊆T. G represents gallery 302, such that G={(S_p, T_p)|∀p∈P}.

A recognition query of search space 404 takes the form q:=(s_u, l_u), where s_u is the signature of a test image u (e.g., test images 401 and 403), and l_u is a logical tag combination for u. The probe u is an unknown person's (user 105) picture taken by one or both of cameras 400 and 402 at the time of recognition. At this point, the unknown person may or may not be an element of P.

A logical tag combination is typically predetermined at the time of a recognition query depending upon the purpose of the query. For example, the party making use of biometric system 30 for functionality 314 may determine that the probe would, for example, have a speaker tag or a VIP tag but would not have a registrant tag. In this instance, the logical tag combination would be l_u:=(t_1 ∨t_2)∨¬t_3. A function f(l_u, T_p) may be defined which returns a Boolean “true” if a logical tag combination l_u corresponds to a person's assigned tags T_p and “false” otherwise. This function allows biometric system 30 to filter gallery 302 signatures for a query q. The filtered set of gallery signatures (search space 404) may be defined as F_q:={S_p|f(l_u, T_p) is true, ∀(S_p, T_p)∈G}. Additionally, a function m(s_u, S_p) may be defined which returns a Boolean “true” if biometric system 30 is confident that person p and probe s_u match and “false” otherwise. The set of possible matches is, thus, defined as M_q:={p|m(s_u, S_p) is true, ∀S_p∈F_q}.

It should be noted that, in the example implementation described with respect to FIG. 4, the logical tags associated with the biometric signatures of gallery 302 reflect privileged information and do not rely on meta-data, such as gender and age, which can be extracted directly from the input using soft biometric approaches.

In addition to speed and accuracy improvements, various aspects of the present disclosure offer enhanced functionality over existing commercial biometric systems. For example, the party making use of biometric system 30 may have constructed multiple groups for distinct purposes where each enrollment might belong to one or more groups. The party may wish to determine if a probe belongs to some groups but not others. In such an instance, the party using biometric system 30 may have two options to complete their task.

In a first option, a query of each group may be made separately and then determine the intersection of the results. For example, assume separate search space groups have been pre-generated from gallery 302 for “attendee” and “VIP” logical tags, where “VIP” is a subset of “attendee.” The party knows that a probe belongs to an attendee, but this person is not a VIP. The party would perform a recognition query on both groups and then remove the results of the “VIP” query from the “attendee” query to reach their final result. The cost is two queries. In a second option, the party may populate and maintain a search space for each notable tag combination. In such an option, the party using biometric system 30 may define a “Not-VIP” group and maintain it in addition to the other existing groups.

Existing legacy biometric systems are unnecessarily computationally complex. The proposed aspects of the present disclosure address the deficiencies with the legacy systems by allowing the improved biometric system to specify the intersection relationship within a single query. A search space may be generated using a customized combination of logic tags. Query times can be drastically improved over the operations of existing systems depending on the value off which represents the size of the filtered gallery.

For example, let us assume that a gallery contains data from 10,000 unique individuals, and that each such individual is assigned a 4-digit PIN. A query which would require submission of an individual's PIN along with the probe image could reduce the search space from 10,000 to as little as two (2) potential matches.

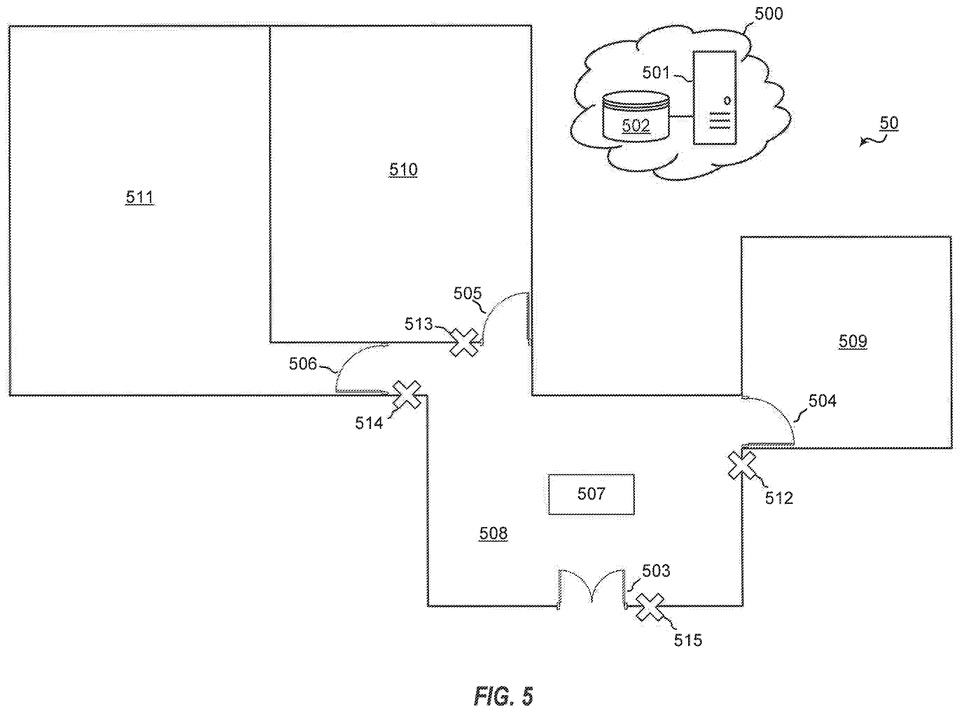

FIG. 5 is a block diagram illustrating biometric system 500 configured according to one aspect of the present disclosure. Biometric system 500 includes computer system 501 and database 502. Database 502 includes enrolled biometric signatures that include one or more associated logical tags assigned according to the various aspects of the present disclosure. For example, database 502 may include a collection of different and varied biometric signatures, such as gallery 302 (FIGS. 3 and 4). The functionalities controlled by biometric system 500 include access control to company building 50. Company building 50 include main entrance 503 and interior room 509-511. Interior room 509 operates typically as a meeting room in which non-employees, vendors, or contractors may be in attendance. Access through door 504 to interior room 509 is controlled by sensor 512. Sensor 512 may, for example, be controlled by biometric system 500 with facial recognition analysis. As all employees would typically have access to interior room 509, a pre-generated search space may be generated from the gallery in database 502 according to all logical tags noting “employee.”

As non-employees may also be allowed to attend events in interior room 509, such non-employees may check in at receptionist station 507. Receptionist station 507 would be equipped with a camera to capture facial images of the non-employee and load into the gallery in database 502. After checking in at receptionist station 507, the uploaded non-employee biometric signature is associated with logical tags identifying “vendor” and “meeting.” The identification of a meeting on the company's schedule may trigger generation of another search space for logical tags identifying “meeting.” Thus, as the non-employee approaches door 504, sensor 512 obtains a test image and uses the test image probe to compare against the generated search space for “meeting” tags. If successfully recognized, the non-employee would be allowed access to interior room 509 via door 504.

Interior room 510 includes sensitive information technology (IT) equipment that requires limited access to only those approved employees. Since the approved employees working at company building 50 are known in advance, a pre-generated search space may be created from the gallery of biometric signatures in database 502 that includes only the signature with the logical tag identifying “IT room access.” Thus, as an approved employee approaches door 505, he or she uses sensor 513 to enter a test image. For example, sensor 513 may include a fingerprint sensor in which the test image probe is fingerprints to be matched against the other biometric signatures of the pre-generated database. However, approved IT employees from other offices of the company may also be granted access when at company building 50. The operations of biometric system 50 include a probe that includes the test image from sensor 513 and an employee person identification number (PIN). Sensor 513 includes a keypad in addition to a fingerprint scanner. Therefore, when an IT employee from a different office is present at company building 50, he or she enters his or her PIN on the keypad and provides a test image fingerprint. Entry of the PIN causes biometric system 50 to dynamically generate a search space from the gallery of database 502. The search space is formed by signatures associated with logical tag of the PIN entered. The test image probe may then be compared against the dynamically generated search space.

Interior room 511 includes restricted workspace but additional options are available for non-employees to obtain access. A pre-generated search space identified by the combination of logical tags “employee,” “employee location,” and “employee title” allows employees to enter door 506 after a facial scan at sensor 514. The test image probe is compared by biometric system 50 against the pre-generated employee search space. On occasion, vendors and contractors may be allowed access to interior room 511. After registering a facial image at receptionist station 507 that is loaded into the gallery at database 502, a dynamic search space is generated using the logical tags “vendor” and “escort required.” As the vendor approaches door 506 sensor 514 captures a test image of the vendor's face. Biometric system 50 compares the test image probe against the dynamically generated vendor search space. When a match is found, the logical tag “escort required” triggers biometric system 50 to prompt for another test image. The prompted for test image is compared to the pre-generated employee search space. Only when both the vendor query and the escorting employee query come back positive will door 506 be unlocked to allow access.

A sensor 515 also provides accessibility to company building 50 after hours when main entrance 503 is locked. For example, sensor 515 may include a fingerprint scanner, facial scanner, iris/retinal scanner, or the like for capturing a test image. From the complete collection of biometric signatures in database 512, a pre-generated employee search may be created using not only employee related logical tags, but a logic tag identifying granted after-hours access. Biometric system 50 would compare the test image probe captured by sensor 515 against the pre-generated search space for employees with after-hours access. If the probe returns with a successful match the employee will be granted access through main entrance 503.

It should be noted that, while the example implementations of the data retrieval systems configured according to aspects of the present disclosure illustrated in FIGS. 3-5 are described in the context of biometric systems, the various aspects and embodiments of the present disclosure are not limited in scope to biometric systems. The various aspects of data retrieval systems according to the present disclosure may be implemented in a variety of data retrieval systems.

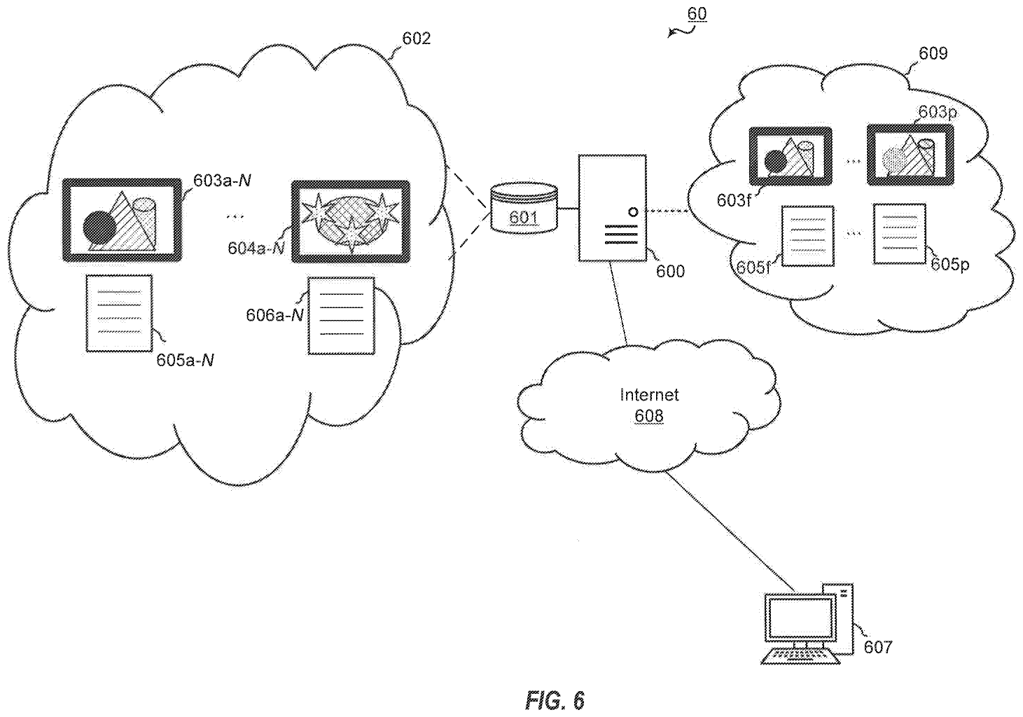

FIG. 6 is a block diagram illustrating an image retrieval system 60 configured according to one aspect of the present disclosure. The various aspects of the present disclosure relate generally to a data retrieval system, such as image retrieval system 60, performing a type of clustering using privileged information (e.g., logical tags) on data signatures of gallery 602 stored in database 601. Image retrieval system 60 includes a computer 600 coupled to database 601. The logic of the improved similarity based operations is included within computer 600 and provides for more efficient operation of computer 600 when providing similarity-based searches of the images within gallery 602. Image signatures 603a-N and 604a-N are added to gallery 602 of database 601. Image signatures 603a-N and 604a-N may be added manually by personnel of the system operator or automatically from existing images or controlled procedures of obtaining such images. As noted with regard to previously illustrated example implementations, operator personnel or automatic machine learning algorithms may associate logical tags 605a-N with image signatures 603a-N and logical tags 606a-N with image signatures 604a-N in gallery 602 of database 601.

In operation of image retrieval system 60, a user at computer 607 desires to search for particular images that may be contained with gallery 602. The user, via computer 607, may log into image retrieval system 60 via Internet 608. The inquiry from computer 607 provides a probe to be compared to the data signatures, image signatures 603a-N or 604a-N. Image retrieval system 60 may further use narrowing descriptions to generate a reduced search space 609. The narrowing descriptions which suggest particular logical tags may be generated automatically by image retrieval system 60 scanning the probe for different features, colors, shapes, and the like. Additionally, the user may enter search terms at computer 607 that may be used to suggest a set of logical tags. Computer 600, in operation of the aspects of the present disclosure, uses the collection of logical tags developed from either or both of the automated scanning and user input to identify one or more of logical tags 605a-N and 606a-N. The selected ones of logical tags 605a-N and 606a-N are then used by computer 600 to create reduced search space 609. It is this reduced search space 609 that computer 600 uses to compare the probe against. The probe may be compared against each of images 603f-603p in reduced search space 609 to identify a likely match with the probe.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIG. 2 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of data retrieval, comprising:
obtaining a test probe for validation of a functionality, wherein the functionality is defined according to a combination of logical tags;
generating a search space as a subset of data signatures of a plurality of known data signatures, each data signature of the plurality of known data signatures being associated with one or more logical tags, wherein the subset of data signatures includes one or more data signatures of the plurality of known data signatures that are associated with the combination of logical tags;
comparing the test probe to each data signature of the search space; and
returning a comparison result of the comparing.

2. The method of claim 1, wherein the comparison result is one of:
a validation of the functionality when the test probe matches one of the subset of data signatures; or
an invalidation of the functionality when the test probe fails to match the one of the subset of data signatures.

3. The method of claim 1, further including:
obtaining one or more known data signatures to enroll in a data retrieval system; and
associating the one or more logical tags with each of the one or more known data signatures.

4. The method of claim 3, further including:
storing the one or more known data signatures and the one or more logical tags associated therewith to the plurality of known data signatures.

5. The method of claim 4, further including:
editing the one or more logical tags associated with the one or more known data signatures.

6. The method of claim 3, wherein the obtaining the one or more known data signatures includes one or more of:
identifying the one or more known data signatures by an operator of the data retrieval system;
receiving the one or more known data signatures from one or more corresponding users of the functionality; or
capturing the one or more known data signatures by a data sensor in communication with the data retrieval system.

7. The method of claim 3, wherein the associating the one or more logical tags includes one or more of:
associating the one or more logical tags by an operator of the data retrieval system;
associating the one or more logical tags by a user of the functionality; or
automatically associating the one or more logical tags.

8. The method of claim 1, wherein the obtaining the test probe includes one or more of:
identifying the test probe by an operator of the data retrieval system;
receiving the test probe from a corresponding user of the functionality; or
capturing the test probe by a data sensor in communication with a data retrieval system.

9. The method of claim 1, wherein the generating the search space is performed one of:
in response to the obtaining the test probe; or
in response to definition of the functionality.

10. The method of claim 9, further including:
defining a plurality of functionalities of the data retrieval system, wherein the functionality is included in the plurality of functionalities, and wherein each functionality of the plurality of functionalities is defined according to a corresponding combination of logical tags.

11. The method of claim 1, wherein the plurality of known data signatures includes one or more of:
biometric data;
image data;
audio data; and
video data.

12. A data retrieval system, comprising:
at least one processor; and
a memory coupled to the at least one processor,
a plurality of data sensors in communication with the at least one processor;
wherein the at least one processor is configured:
to obtain a test probe for validation of a functionality, wherein the functionality is defined according to a combination of logical tags;
to generate a search space as a subset of data signatures of a plurality of known data signatures in the memory, each data signature of the plurality of known data signatures being associated with one or more logical tags, wherein the subset of data signatures includes one or more data signatures of the plurality of known data signatures that are associated with the combination of logical tags;
to compare the test probe to each data signature of the search space; and
to return a comparison result of the comparing.

13. The data retrieval system of claim 12, wherein the comparison result is one of:
a validation of the functionality when the test probe matches one of the subset of data signatures; or
an invalidation of the functionality when the test probe fails to match the one of the subset of data signatures.

14. The data retrieval system of claim 12, further including configuration of the at least one processor:
to obtain one or more known data signatures to enroll in the data retrieval system; and
to associate the one or more logical tags with each of the one or more known data signatures.

15. The data retrieval system of claim 14, further including configuration of the at least one processor:
to store the one or more known data signatures associated with the one or more logical tags to the plurality of known data signatures in the memory.

16. The data retrieval system of claim 15, further including configuration of the at least one processor:
to edit the one or more logical tags associated with the one or more known data signatures.

17. The data retrieval system of claim 14, wherein the configuration of the at least one processor to obtain the one or more known data signatures includes configuration of the at least one processor to one or more of:
receive input of the one or more known data signatures by an operator of the data retrieval system;
receive input of the one or more known data signatures from one or more corresponding users of the functionality; or
capture the one or more known data signatures by at least one data sensor of the plurality of data sensors.

18. The data retrieval system of claim 14, wherein the configuration of the at least one processor to associate the one or more logical tags includes configuration of the at least one processor to one or more of:
receive input by an operator of the data retrieval system to associate the one or more logical tags;
receive input by a user of the functionality to associate the one or more logical tags; or
automatically determining association of the one or more logical tags by the data retrieval system.

19. The data retrieval system of claim 12, wherein the configuration of the at least one processor to obtain the test probe includes configuration of the at least one processor to one or more of:
receive input by an operator of the data retrieval system to identify the test probe;
receive input by a corresponding user of the functionality of the test probe; or
capture the test probe by at least one data sensor of the plurality of data sensors.

20. The data retrieval system of claim 12, wherein the configuration of the at least one processor to generate the search space is performed one of:
in response to the obtaining of the test probe; or
in response to definition of the functionality.

21. The data retrieval system of claim 20, further including configuration of the at least one processor to define a plurality of functionalities of the data retrieval system, wherein the functionality is included in the plurality of functionalities, and wherein each functionality of the plurality of functionalities is defined according to a corresponding combination of logical tags.

22. The data retrieval system of claim 21, wherein the configuration of the at least one processor to define the plurality of functionalities includes configuration of the at least one processor to receive input from an operator of the data retrieval system of the corresponding combination of logical tags defining each of the plurality of functionalities.

23. The data retrieval system of claim 12, wherein the plurality of known data signatures includes one or more of:
biometric data;
image data;
audio data; and
video data.
